(19) United States
(12) Patent Application Publication
(10) Pub. No.: US 2017/0361801 A1
(43) Pub. Date: Dec. 21, 2017

(54) MOUNTING STRUCTURE FOR DRIVER-SEAT AIRBAG DEVICE

(71) Applicant: TOYODA GOSEI CO., LTD., Kiyosu-shi (JP)

(72) Inventor: Yoshiteru BANNO, Kiyosu-shi (JP)

(21) Appl. No.: 15/621,238

(22) Filed: Jun. 13, 2017

(30) Foreign Application Priority Data
Jun. 16, 2016 (JP) 2016-119735

(51) Int. Cl. B60R 21/203; B60Q 5/00; B60R 21/2165

(52) U.S. Cl. CPC B60R 21/2037; B60R 21/21658; B60Q 5/003; B60R 21/2035

(57) ABSTRACT

A mounting structure for a driver-seat airbag device for mounting an airbag device to a main body of a steering wheel, the mounting structure includes: a core metal provided on the main body of the steering wheel; and a base plate mounted to the core metal; a snap pin, provided on the airbag device, the snap pin protruding toward the base plate; a separate holding member mounted to a mounting portion of the base plate; and a clip engaged with the holding member, wherein the snap pin is held by the holding member and is engaged with the clip so that the airbag device is mounted to the main body.

### CROSS-REFERENCE TO RELATED APPLICATION(S)

This application is based upon and claims the benefit of priority from Japanese Patent Application No. 2016-119735, filed on Jun. 16, 2016, the entire contents of which are incorporated herein by reference.

### BACKGROUND

### 1. Field of the Invention

The present invention relates to a mounting structure for a driver-seat airbag device for mounting an airbag device to a main body of a steering wheel.

### 2. Description of the Related Art

JIB-A-2016-30552 discloses a mounting structure of mounting a driver-seat airbag device (hereinafter referred to as an airbag device) to a main body of a steering wheel of an automobile.

In JP-A-2016-30552, a through hole is formed in a core metal which constitutes the main body of the steering wheel. A clip is mounted to a rear surface of the core metal along the rear surface so as to cross the through hole. When a pair of snap pins provided on the rear surface of the airbag device are inserted into the through hole of the core metal and engaged with the clip, the airbag device is mounted to the main body.

In recent years, while the airbag device tends to be miniaturized according to market needs, from an object of reducing the vibration transmitted from the tire to the steering wheel, a boss portion of the core metal into which the steering shaft is inserted is tend to increase in diameter. Therefore, it is difficult to secure a space for mounting the snap pin in the hub portion having the boss portion of the core metal.

Therefore, in a steering wheel described in JP-A-2010-116060, a base plate is mounted to a front surface of the hub portion of the core metal. A pair of insertion holes are formed in the base plate so as to interpose the boss portion therebetween. A clip having an inverted U-shape is mounted to the rear surface of the base plate along the rear surface so as to cross the pair of insertion holes. Further, a pair of hook portions (corresponding to the snap pins of JP-A-2016-30552) provided on the rear surface of the airbag device are respectively inserted through the pair of insertion holes of the base plate, and are engaged with the clip. Thus, the airbag device is mounted to the main body.

However, in the mounting structure described in JP-A-2010-116060, the snap pin is held by being in contact with the inner peripheral surface of the insertion hole of the base plate and is engaged with the clip. However, since the thickness of the base plate, that is, the thickness of the inner peripheral surface of the insertion hole is small, it is difficult to properly hold the snap pin. In contrast, it is conceivable to secure the thickness of the inner peripheral surface of the insertion hole, for example, by setting the thickness of the portion including the insertion hole to be partly thicker than the other portions. However, in this case, there is a contradiction in which the shape of the base plate becomes complicated.

### SUMMARY

An object of the present invention is to provide a mounting structure for a driver-seat airbag device capable of suppressing complication of the shape of a base plate, while properly holding a snap pin.

In order to achieve the above object, according to an aspect of the present invention, according to an aspect of the invention, there is provided a mounting structure for a driver-seat airbag device for mounting an airbag device to a main body of a steering wheel, the mounting structure including: a core metal provided on the main body of the steering wheel; and a base plate mounted to the core metal; a snap pin provided on the airbag device, the snap pin protruding toward the base plate; a separate holding member mounted to a mounting portion of the base plate; and a clip engaged with the holding member, wherein the snap pin is held by the holding member and is engaged with the clip so that the airbag device is mounted to the main body.

According to this configuration, since the separate holding members that hold the snap pins are provided in the mounting portion of the base plate, it is possible to secure the thickness of the member on the main body side for properly holding the snap pin by the holding member.

Further, according to the above configuration, since the clip is mounted to the base plate via the holding member, it is not necessary to provide the base plate with a portion for mounting the clip.

Therefore, it is possible to prevent the shape of the base plate from becoming complicated, while properly holding the snap pin.

According to the mounting structure for the driver-seat airbag device of the present invention, the clip may have: a pair of arms disposed with a boss portion of the main body interposed therebetween; and a connecting portion configured to connect base ends of the pair of arms, and the holding member may include a pair of first holding members provided to correspond to the pair of arms and respectively engaged with the pair of arms.

According to the above configuration, since the pair of snap pins of the airbag device are held by the pair of first holding members, respectively, and engaged with the pair of arms, respectively, the airbag device is mounted to the main body. Therefore, the airbag device is stably mounted to the main body.

According to the mounting structure for the driver-seat airbag device of the present invention, the holding member may include a second holding member provided to correspond to the connecting portion and engaged with the connecting portion.

According to this configuration, the second holding member is also engaged with the connecting portion that connects the base ends of the pair of arms. Further, since the snap pin of the airbag device is held by the second holding member and engaged with the connecting portion, the airbag device is mounted to the main body. Therefore, the airbag device is more stably mounted to the main body.

According to the mounting structure for the driver-seat airbag device of the present invention, the mounting portion may be an engaging hole formed in the base plate; and the holding member may have a storage portion configured to store the snap pin and is engaged with the engaging hole.

According to the configuration, the shape of the base plate is simplified, and the base plate can be easily formed.

According to the mounting structure for the driver-seat airbag device of the present invention, the engaging hole may be a circular hole, and the holding member may be rotatably engaged with the engaging hole in a state in which the clip is not engaged with the holding member, and the holding member may be non-rotatably engaged with the engaging hole in a state in which the clip is engaged with the holding member.

According to this configuration, since the engaging holes are circular holes, the shape of the base plate is simplified. In addition, by inserting the holding member into the engaging holes, the holding member can be easily engaged with the engaging holes. When the clip is engaged with the holding member, since the holding member engaged with the engaging holes cannot rotate, it is possible to perform positioning of the holding member simultaneously with mounting of the clip.

According to the mounting structure for the driver-seat airbag device of the present invention, the base plate may be provided with a pair of holding portions capable of holding the pair of arms of the clip, respectively, in a state in which the holding member is not engaged with the engaging hole.

According to such a configuration, in a state in which the holding member is not engaged with the engaging holes, the pair of arms of the clip are held by the pair of holding portions of the base plate. Therefore, it is possible to easily and smoothly perform the assembling work for engaging the holding member with the engaging holes of the base plate and holding the clip on the holding member.

According to the mounting structure for the driver-seat airbag device of the present invention, the holding member may have a tapered shape toward an end portion on the main body side of the holding member.

According to this configuration, the holding member can be easily inserted into and engaged with the engaging hole.

According to the mounting structure for the driver-seat airbag device of the present invention, an engaging recess with which the pair of arms are engaged may be formed on a peripheral wall of the first holding member, the first holding member may have an inclined surface formed by cutting the peripheral wall so as to incline with respect to a central axis from the engaging recess to a leading end, and the holding member may have the tapered shape toward the end portion on the main body side of the holding member by the inclined surface.

According to the above configuration, when the first holding member is inserted into the engaging holes of the base plate, since the clip relatively moves on the inclined surface of the first holding member, the insertion of the first holding member into the engaging holes is guided and the engagement of the clip to the engaging recess is guided. Thus, the clip can be easily engaged with the engaging recess.

According to the mounting structure for the driver-seat airbag device of the present invention, an inner peripheral surface of the storage portion of the holding member may be reduced in diameter toward the main body.

According to this configuration, the snap pin is easily inserted into the storage portion of the holding member, and the snap pin is smoothly guided toward the engagement position with the clip. Therefore, the mounting of the airbag device can be easily performed.

According to the mounting structure for the driver-seat airbag device of the present invention, each of the pair of arms may have: inclined portions which are inclined so as to be closer to each other toward the leading end sides of the pair of arms; and a leading end portion which extends from a leading end of the inclined portion; an engaging recess with which the leading end portions of the pair of arms are engaged may be formed on the peripheral wall of the pair of first holding members, the pair of first holding members may be engaged with the engaging holes in a posture in which the engaging recess is opened inward in a width direction, and the base plate may be provided with a guide portion which is brought into contact with the inclined portions of the pair of arms, respectively, and guides the inclined portions in a direction of coming closer to each other with the movement of the clip from the base end sides of the pair of arms to the leading end sides.

According to this configuration, when the clip is moved from the base end side of the pair of arms toward the leading end side with respect to the base plate, the inclined portions of the pair of arms are guided in a direction of coming closer to each other due to the action of the guide portion. As a result, the leading end portions of the pair of arms are displaced inward in the width direction and the engagement with the engaging recess of the pair of holding members is released, and thus, the airbag device can be detached from the main body.

According to the mounting structure for the driver-seat airbag device of the present invention, a plurality of positioning protrusions may be formed on the core metal, and the base plate may be formed with a plurality of through holes through which the plurality of protrusions penetrate, respectively.

According to such a configuration, by disposing the base plate on the core metal so that the plurality of protrusions of the core metal penetrate through the plurality of through holes of the base plate, respectively, the base plate can be easily positioned on the core metal. Therefore, it is possible to easily perform the operation of mounting the base plate to the core metal.

According to the present invention, it is possible to prevent the shape of the base plate from becoming complicated, while properly holding the snap pin.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1 is a perspective view illustrating a steering wheel provided with a mounting structure in an embodiment of the mounting structure for a driver-seat airbag device;

FIG. 2 is a side view illustrating a main body of the steering wheel and the airbag device in the embodiment in a state of being separated from each other;

FIG. 3 is a front view illustrating a state in which the airbag device and the left and right bezels are detached from the steering wheel in the embodiment;

FIG. 4A is a front view illustrating a base plate in a state in which a holding member and a clip of the embodiment are mounted, and FIG. 4B is a rear view illustrating the base plate;

FIG. 5 is a perspective view illustrating the base plate from the back side in a state in which the clip is mounted via the holding member of the embodiment;

FIG. 6 is a perspective view illustrating the holding member of the embodiment; and

FIG. 7A is a cross-sectional view illustrating a way of inserting the holding member into the engaging hole of the base plate of the embodiment, FIG. 7B is a cross-sectional view illustrating a state in which the holding member is engaged with the engaging hole and the clip is engaged with an engaging recess, and FIG. 7C is a cross-sectional view illustrating a state in which the snap pin is held by the holding member and engaged with the clip.

### DETAILED DESCRIPTION OF THE INVENTION

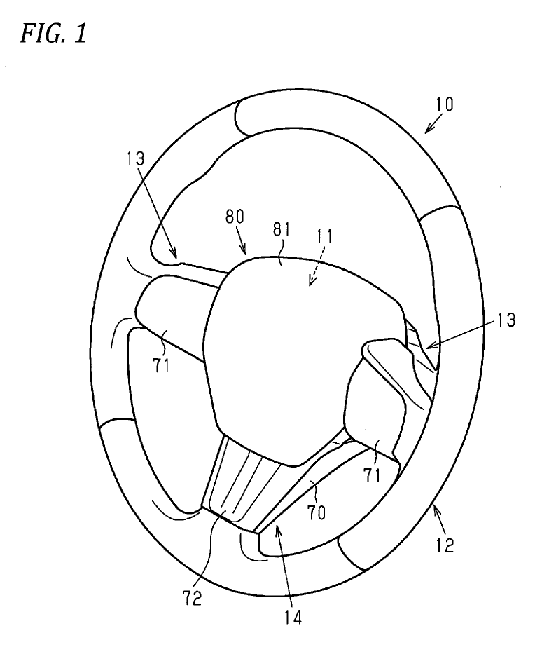

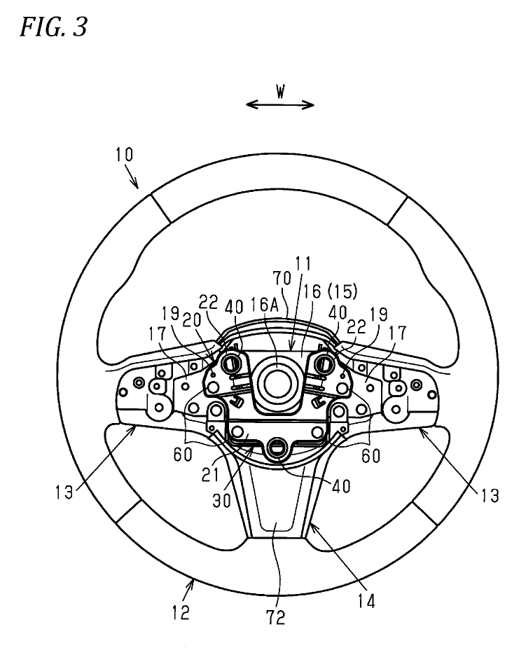

An embodiment will be described below with reference to FIGS. 1 to 7C. In the following description, a vertical direction (a vertical direction illustrated in FIG. 3) when the steering wheel is viewed from the front is defined as a “vertical direction”, and a width direction (a horizontal direction illustrated in FIG. 3) when the steering wheel is viewed from the front is defined as a “width direction W”.

As illustrated in FIGS. 1 to 3, a main body 10 of a steering wheel includes a hub portion 11, a ring portion 12 positioned on an outer peripheral side of the hub portion 11, a pair of true spoke portions 13 and a pseudo-spoke portion 14 which connect the hub portion 11 and the ring portion 12. A driver-seat airbag device (hereinafter referred to as an airbag device 80) is mounted to the main body 10 from the front side.

As illustrated in FIG. 3, the main body 10 is provided with a core metal 15 forming a skeleton, and a base plate 20 mounted to the core metal 15 from the front side. The airbag device 80 is mounted to the main body 10 via the base plate 20.

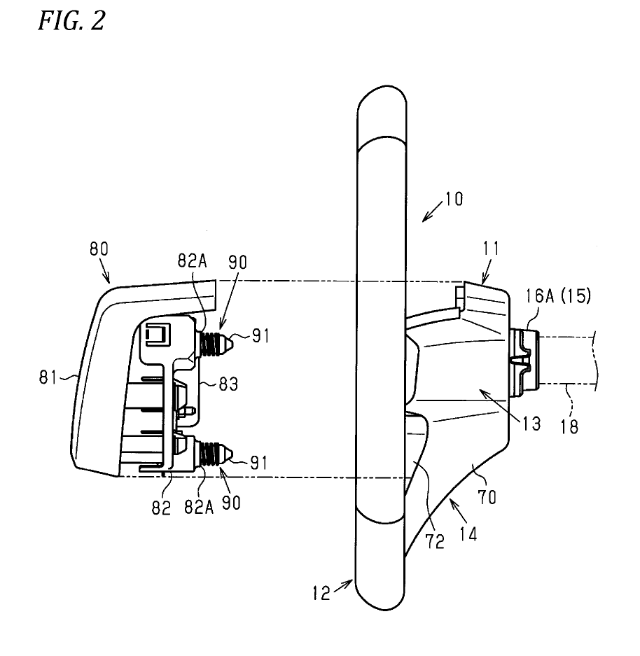

The core metal 15 has a core metal hub portion 16 constituting the hub portion 11, a ring portion (not illustrated) constituting the ring portion 12, and a pair of core metal spoke portions 17 constituting the pair of true spoke portions 13. The core metal 15 is integrally formed of a metallic material such as an aluminum alloy. The core metal 15 does not exist in the interior of the pseudo-spoke portion 14. A cylindrical boss 16A made of a metal material harder than the core metal 15 such as a steel material is fitted to the hole formed in the center of the core metal hub portion 16. As indicated by the two-dot chain line in FIG. 2, one end portion of the steering shaft 18 is inserted and fixed to the boss 16A.

As illustrated in FIGS. 1 and 2, a back cover 70 that forms a design surface is mounted to the rear side of each of the hub portion 11 and the spoke portions 13 and 14. A pair of bezel covers 71 that form a design surface are mounted to the front side of the pair of true spoke portions 13. A bezel cover 72 that forms a design surface is mounted to the front side of the pseudo-spoke portion 14.

Next, the base plate 20 will be described.

As illustrated in FIGS. 3, 4A, 4B, and 5, the base plate 20 has a symmetrical shape in a front view. That is, the base plate 20 includes a base portion 21 positioned below the boss 16A and extending along the width direction W, and a pair of extending portions 22 extending upward from both end portions in the width direction W of the base portion 21, and has a generally U-shape opened upward as a whole. The pair of extending portions 22 are located outside the boss 16A in the width direction W, respectively. The peripheral edge of the base plate 20 has a shape bent toward the front side, and the rigidity of the base plate 20 is enhanced. The base plate 20 is made of a metal material such as an aluminum alloy.

Four screw holes 23 are formed at both end portions of the base portion 21 in the width direction W and at the outer portion of each extending portion 22 in the width direction W. When the screw 60 is inserted through the screw holes 23 and the screw 60 is screwed into a female screw (not illustrated) formed in the core metal hub portion 16 of the core metal 15, the base plate 20 is mounted to the core metal 15.

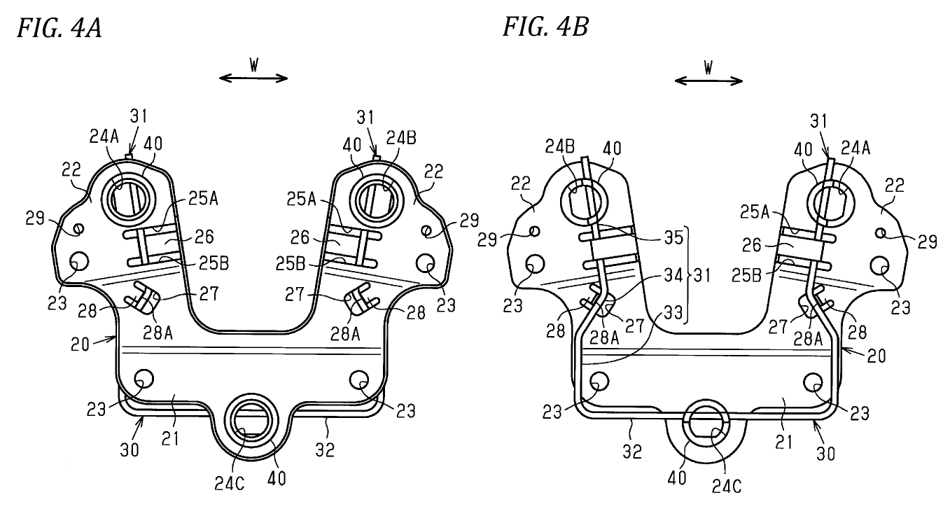

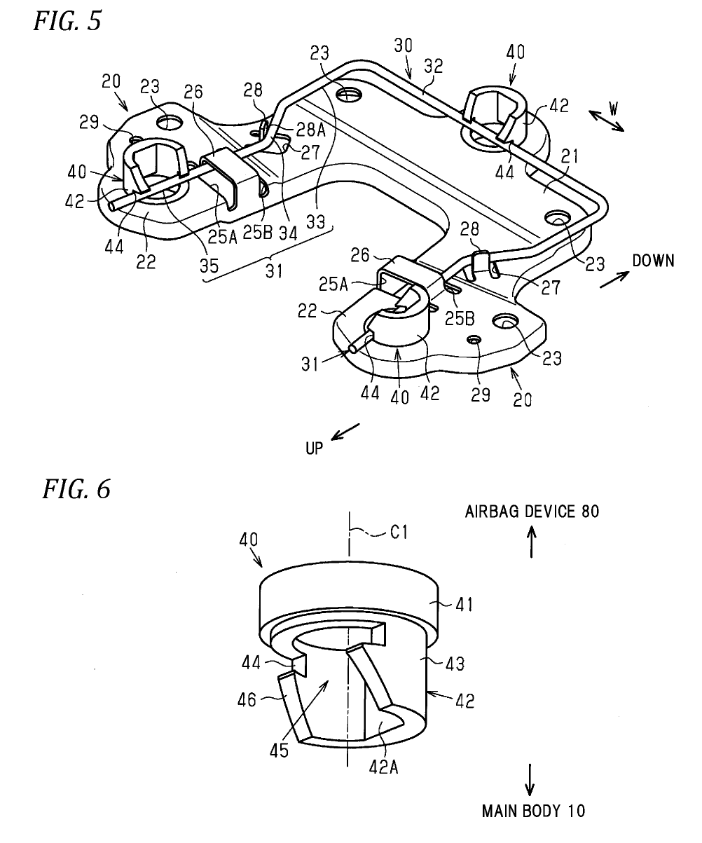

As illustrated in FIGS. 4A, 4B, and 5, circular engaging holes 24A and 24B are formed in the upper end portions of the respective extending portions 22. A central portion of the base portion 21 in the width direction W protrudes downward in a substantially arcuate shape, and a circular engaging hole 24C is formed in the protruding portion thereof. All the engaging holes 24A to 24C have the same shape.

An upper through hole 25A and a lower through hole 25B are formed below the engaging holes 24A and 24B in each extending portion 22. Between the through holes 25A and 25B, a holding portion 26 protruding toward the rear side from the upper edge portion of the upper through hole 25A and the lower edge portion of the lower through hole 25B is formed. The holding portion 26 is connected to the main body of the base plate 20 at both ends in the width direction W, respectively.

A through hole 27 is formed in a portion of each extending portion 22 that is closer to the base end side than each lower through hole 25B. A guide protrusion 28 is formed on an inner peripheral edge on the outer side of the through hole 27 in the width direction W. The guide protrusion 28 extends toward the inner peripheral side and is bent and protrudes toward the rear side. Each of the guide protrusions 28 is a surface facing the inner side in the width direction W, and has a guide surface 28A that is inclined so as to be located on the inner side in the width direction W with approach to the upper side.

A through hole 29 having a diameter smaller than that of the screw hole 23 is formed above the screw hole 23 in each extending portion 22. A pair of positioning protrusions 19 projecting to the front surface of the metal core 15 penetrate through the pair of through holes 29.

Next, the holding member 40 will be described.

As illustrated in FIGS. 3, 4A, 4B, and 5, the holding members 40 having a substantially cylindrical shape are respectively inserted and engaged from the front side into the engaging holes 24A to 24C of the base plate 20. Further, the holding member 40 engaged with the left and right engaging holes 24A and 24B corresponds to the first holding member, and the holding member 40 engaged with the lower engaging hole 24C corresponds to the second holding member.

As illustrated in FIG. 6, the holding member 40 has a cylindrical base end portion 41 and a reduced diameter portion 42 having a diameter smaller than that of the base end portion 41, and is integrally formed of a rigid resin material.

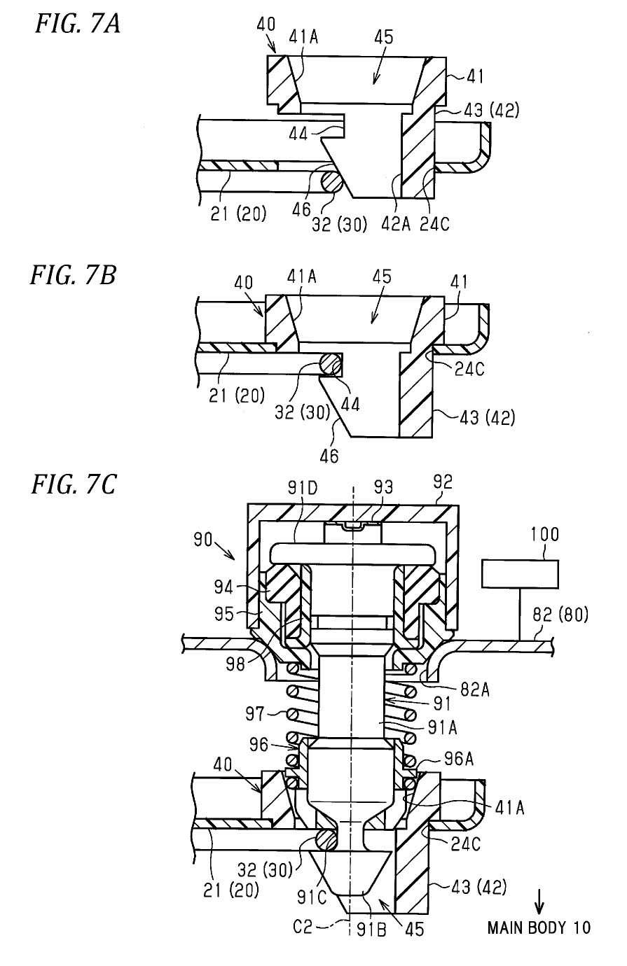

As illustrated in FIG. 7C, a step portion formed by the base end portion 41 and the reduced diameter portion 42 is engaged with the inner peripheral edge of the engaging hole 24C. Therefore, the holding member 40 is rotatably engaged with the engaging holes 24A to 24C in a state in which the clip 30 to be described later is not engaged with the holding member 40.

As illustrated in FIGS. 7A to 7C, the inner peripheral surface 41A of the base end portion 41 is reduced in diameter toward the main body 10, and the inner diameter of the leading end of the base end portion 41 is set to be the same as the inner diameter of the reduced diameter portion 42.

As illustrated in FIG. 6, the peripheral wall 43 of the reduced diameter portion 42 is formed with an engaging recess 44 which is cut out over substantially a half circumference at a predetermined width. An inclined surface 46 is formed by an end surface that a portion of the peripheral wall 43 of the reduced diameter portion 42 on the leading end side (body 10 side) is cut to incline with respect to the central axis C1 of the holding member 40 from the engaging recess 44 to the leading end. Accordingly, the holding member 40 has a tapered shape toward the end portion of the holding member 40 on the side of the main body 10 due to the inclined surface 46.

On the inner peripheral surface of the reduced diameter portion 42, a planar portion 42A extending along the central axis C1 is formed on the opposite side of the engaging recess 44 with the central axis C1 interposed therebetween.

The internal space of the holding member 40 functions as a storage portion 45 for storing the snap pin 91 of the airbag device 80 to be described later.

Next, the clip 30 will be described.

As illustrated in FIGS. 4A, 4B, and 5, a clip 30 is provided on the rear side of the base plate 20.

The clip 30 has a symmetrical shape in a front view. That is, the clip 30 has a pair of left and right arms 31 arranged with the boss 16A of the main body 10 interposed therebetween, and a connecting portion 32 which connects the base ends of the pair of arms 31 to each other, and has a substantially inverted U-shape as a whole.

Each arm 31 has a base end portion 33 extending from the connecting portion 32 and extending upward in the vertical direction, and an inclined portion 34 extending from the leading end of the base end portion 33 and extending obliquely so as to be positioned on the inner side in the width direction W with approach to the upper side. Therefore, the inclined portions 34 of the respective arms 31 are inclined so as to be closer to each other toward the leading end side.

Each arm 31 has a leading end portion 35 that extends from the leading end of the inclined portion 34 and extends obliquely so as to be located on the outer side in the width direction W toward the upper side, and each of the leading end portions 35 serves as a free end.

The leading end portions 35 of the respective arms 31 pass through the respective lower through holes 25B of the base plate 20 from the lower side, and pass through the upper through holes 25A through the front sides of the respective holding portions 26.

As illustrated in FIG. 5, in a state in which the clip 30 is engaged with the holding member 40, the left and right holding members 40 are engaged with to the engaging holes 24A and 24B in a posture in which the engaging recesses 44 are opened inward in the width direction W, respectively. The leading end portions 35 of the arms 31 are engaged with the engaging recesses 44 from the inside in the width direction W, respectively. At this time, the leading end portion 35 is engaged with the holding member 40 so as to cross the storage portion 45.

Further, the lower holding member 40 is engaged with the engaging hole 24C in a posture in which the engaging recess 44 is opened upward. The connecting portion 32 of the clip 30 is engaged with the engaging recess 44 from the upper side. At this time, the connecting portion 32 is engaged with the holding member 40 so as to cross the storage portion 45.

The inclined portion 34 of each arm 31 of the clip 30 is in contact with each guide surface 28A of the base plate 20.

In a state in which the clip 30 is engaged with each holding member 40, each holding member 40 is non-rotatably engaged with the engaging holes 24A to 24C.

In a state in which the clip 30 is not engaged with each holding member 40, each of the leading end portions 35 of the clip 30 tends to spread outward in the width direction W by the restoring force. At this time, the respective leading end portions 35 of the clip 30 are held by the holding portions 26, and thus the leading end portion 35 is held.

Next, the airbag device 80 will be described.

As illustrated in FIG. 2, the airbag device 80 is provided with a pad 81 which is formed of a rigid resin material and constitutes a design surface on the front side. Further, a bag holder 82, which is formed of a conductive metal material and holds an air bag (not illustrated) between the pad 81, is mounted to the back side of the pad 81. An inflator 83 for supplying inflation gas to the airbag is mounted to the back side of the bag holder 82.

As illustrated in FIG. 7C, a mounting hole 82A is formed at a position corresponding to the engaging hole 24C of the base plate 20 in the bag holder 82. Mounting holes (not illustrated) having the same shape as the mounting holes 82A are also formed at positions corresponding to the other two engaging holes 24A and 24B in the bag holder 82. The horn device 100 is electrically connected to the bag holder 82.

As illustrated in FIGS. 2 and 7C, a horn switch mechanism 90 to be described later is mounted to each mounting hole 82A from the front side.

As illustrated in FIG. 2, the snap pins 91 of each horn switch mechanism 90 protrude toward the main body 10 from the bag holder 82.

Next, the horn switch mechanism 90 will be described.

As illustrated in FIG. 7C, the snap pin 91 of the horn switch mechanism 90 is formed of a conductive metal material. The snap pin 91 has a shaft portion 91A, a tapered head portion 91B, and an annular locking groove 91C formed between the shaft portion 91A and the head portion 91B. A flange portion 91D is formed at a base end portion of the snap pin 91.

A cylindrical portion 98 made of an insulating rigid resin material is put on the outer peripheral surface of the base end portion of the shaft portion 91A. The base end of the cylindrical portion 98 is in contact with the flange portion 91D.

A cylindrical elastic member 94 made of an elastic material such as rubber (e.g., EPDM, silicone rubber) or an elastomer is put on the outer peripheral surface of the cylindrical portion 98.

A cylindrical damper holder 95 formed of an insulating rigid resin material is put on the outer peripheral surface of the base end portion of the elastic member 94. The leading end portion of the damper holder 95 is reduced in diameter to cover the leading end portion of the cylindrical portion 98 from the leading end side.

The leading end portion of the damper holder 95 is inserted into the mounting hole 82A of the bag holder 82, and a mounting portion (not illustrated) of the damper holder 95 is mounted to the bag holder 82. The elastic member 94 is held slidably along the central axis C2 of the mounting hole 82A by the damper holder 95.

On the outer peripheral surface of the damper holder 95, a bottomed cylindrical contact holder 92 which is formed of an insulating rigid resin material and covers the flange portion 91D of the snap pin 91 from the front side is mounted by a claw fitting (not illustrated) or the like.

A movable side contact portion 93 is mounted to the inner bottom surface and the inner peripheral surface of the contact holder 92. The movable side contact portion 93 is in contact with the bag holder 82.

On the outer peripheral surface of the snap pin 91, a substantially cylindrical auxiliary member 96 which is formed of an insulating rigid resin material and covers a portion on the base end side of the locking groove 91C and a part of the shaft portion 91A connected to the locking groove 91C is covered.

An annular storage portion 96A protrudes from the outer peripheral surface of the auxiliary member 96. A coil spring 97 is interposed between the storage portion 96A and the damper holder 95.

When the air bag device 80 is pushed down, the force applied to the air bag device 80 causes the contact holder 92, the movable side contact portion 93, and the damper holder 95 to slide to the rear side, while receiving the elastic repulsive force of the coil spring 97 along the snap pin 91. At this time, when the movable side contact portion 93 is brought into contact with the flange portion 91D of the snap pin 91 which is the fixed side contact portion, and is conductively connected thereto, the horn device 100 is operated.

The leading end portion of the snap pin 91 is stored by the storage portion 45 of the holding member 40, and the auxiliary member 96 is held by the inner peripheral surface of the holding member 40. At this time, the clip 30 (in this case, the connecting portion 32) is engaged with the locking groove 91C of the snap pin 91. In this way, the airbag device 80 is mounted to the main body 10.

Next, a procedure for assembling the clip 30 and the holding member 40 to the base plate 20 will be described.

First, the clip 30 is assembled to the rear surface of the base plate 20. At this time, the inclined portion 34 of the clip 30 is brought into contact with the guide surface 28A of the base plate 20, and the leading end portion 35 of the clip 30 is held by the holding portion 26.

Subsequently, as illustrated in FIG. 7A, the holding member 40 is inserted into the engaging hole 24C of the base plate 20 from the front side. At this time, as the clip 30 relatively moves on the inclined surface 46 of the holding member 40, the insertion of the holding member 40 into the engaging hole 24C is guided, and the engagement of the clip 30 to the engaging recess 44 is guided. As a result, as illustrated in FIG. 7B, the clip 30 is engaged with the engaging recess 44 of the holding member 40.

Also, in the other two engaging holes 24A and 24B, the holding member 40 is inserted from the front side in the same manner as the engaging hole 24C, and the leading end portion 35 of each arm 31 of the clip 30 is engaged into the engaging recess 44 of each holding member 40.

As illustrated in FIGS. 4A and 4B, in a state in which the clip 30 is engaged with each holding member 40, a downward force acts on each inclined portion 34 of the clip 30 by each guide surface 28A of the base plate 20. Therefore, the connecting portion 32 of the clip 30 is pressed downward against the engaging recess 44 of the lower holding member 40. Therefore, the connecting portion 32 is prevented from coming-off from the engaging recess 44.

On the other hand, when the clip 30 is detached from the base plate 20, the clip 30 is moved upward with respect to the base plate 20. At this time, as the connecting portion 32 of the clip 30 engaged with the lower holding member 40 moves upward, the engagement state between the engaging recess 44 and the connecting portion 32 is released. Also, when each inclined portion 34 of the clip 30 is guided by each guide surface 28A, the respective inclined portions 34 are deformed to approach each other in the width direction W. As a result, since the leading end portion 35 of the clip 30 engaged with the left and right holding members 40 moves inward in the width direction W, the engagement state between the engaging recess 44 and the leading end portion 35 is released.

According to the mounting structure of the airbag device for a driver-seat of the present embodiment described above, the following operational effects can be obtained.

(1) A separate holding member 40 is engaged with the engaging holes 24A to 24C of the base plate 20. When the clip 30 is engaged with the holding member 40, and the snap pin 91 is stored and held by the storage portion 45 of the holding member 40 and is engaged with the clip 30, the airbag device 80 is mounted to the main body 10.

According to such a configuration, since the separate holding members 40 that hold the snap pins 91 are provided in the engaging holes 24A to 24C of the base plate 20, it is possible to secure the thickness of the member on the main body 10 side for properly holding the snap pin 91 by the holding member 40.

Further, according to the above configuration, since the clip 30 is mounted to the base plate 20 via the holding member 40, it is not necessary to provide the base plate 20 with a portion for mounting the clip 30.

Therefore, it is possible to prevent the shape of the base plate 20 from becoming complicated, while properly holding the snap pin 91.

(2) The holding member 40 is mounted to the base plate 20, by engaging the holding member 40 with the engaging holes 24A to 24C of the base plate 20. Therefore, the shape of the base plate 20 is simplified, and the base plate 20 can be easily formed.

(3) The holding member 40 includes a pair of holding members 40 provided to correspond to the pair of arms 31 and engaged with the pair of arms 31, respectively.

According to such a configuration, since the pair of snap pins 91 of the airbag device 80 are held by the pair of holding members 40, respectively, and engaged with the pair of arms 31, respectively, the airbag device 80 is mounted to the main body 10. Therefore, the airbag device 80 is stably mounted to the main body 10.

(4) The holding member 40 includes a holding member 40 provided to correspond to the connecting portion 32 and engaged with the connecting portion 32.

According to such a configuration, the holding member 40 is also engaged to the connecting portion 32 that connects the base ends of the pair of arms 31. Further, since the snap pin 91 of the airbag device 80 is held by the holding member 40 and engaged with the connecting portion 32, the airbag device 80 is mounted to the main body 10. Therefore, the airbag device 80 is stably mounted to the main body 10.

(5) Since the engaging holes 24A to 24C are circular holes. The holding member 40 is rotatably engaged with respect to the engaging holes 24A to 24C in a state in which the clip 30 is not engaged with the holding member 40. Meanwhile, the holding member 40 is non-rotatably engaged with the engaging holes 24A to 24C in a state in which the clip 30 is engaged with the holding member 40.

With such a configuration, since the engaging holes 24A to 24C are circular holes, the shape of the base plate 20 is simplified. In addition, by inserting the holding member 40 into the engaging holes 24A to 24C, the holding member 40 can be easily engaged with the engaging holes 24A to 24C. When the clip 30 is engaged with the holding member 40, since the holding member 40 engaged with the engaging holes 24A to 24C cannot rotate, it is possible to perform positioning of the holding member 40 simultaneously with mounting of the clip 30.

(6) The base plate 20 is provided with a pair of holding portions 26 capable of respectively holding the pair of arms 31 of the clip 30 in a state in which the holding member 40 is not engaged with the engaging holes 24A to 24C.

According to such a configuration, in a state in which the holding member 40 is not engaged with the engaging holes 24A to 24C, the pair of arms 31 of the clip 30 are held by the pair of holding portions 26 of the base plate 20. Therefore, it is possible to easily and smoothly perform the assembling work for engaging the holding member 40 with the engaging holes 24A to 24C of the base plate 20 and holding the clip 30 on the holding member 40.

(7) The holding member 40 has a tapered shape toward the end portion of the holding member 40 on the side of the main body 10. Therefore, the holding member 40 can be easily inserted into and engaged with the engaging holes 24A to 24C.

(8) The holding member 40 has an inclined surface 46 formed by cutting the peripheral wall 43 so as to incline with respect to the central axis C1 from the engaging recess 44 formed in the peripheral wall 43 to the leading end.

According to such a configuration, when the holding member 40 is inserted into the engaging holes 24A to 24C of the base plate 20, since the clip 30 relatively moves on the inclined surface 46 of the holding member 40, the insertion of the holding member 40 into the engaging holes 24A to 24C is guided and the engagement of the clip 30 to the engaging recess 44 is guided. Thus, the clip 30 can be easily engaged with the engaging recess 44.

(9) As the inner peripheral surface 41A of the base end portion 41 of the holding member 40 approaches the main body 10, the diameter thereof is reduced. Therefore, the snap pin 91 is easily inserted into the interior (the storage portion 45) of the base end portion 41 of the holding member 40, and the snap pin 91 is smoothly guided toward the engagement position with the clip 30. Therefore, the mounting of the airbag device 80 can be easily performed.

(10) The base plate 20 is provided with the guide surfaces 28A which come into contact with the inclined portions 34 of the pair of arms 31, respectively, and guide the inclined portions 34 in the direction of approaching each other with the movement of the clip 30 from the base end side to the leading end side of the pair of arms 31.

According to such a configuration, when the clip 30 is moved from the base end side of the pair of arms 31 toward the leading end side with respect to the base plate 20, the inclined portions 34 of the pair of arms 31 are guided in a direction of coming closer to each other due to the action of the guide surface 28A. As a result, since the leading end portions 35 of the pair of arms 31 are displaced inward in the width direction and the engagement with the pair of holding members 40 is released, the airbag device 80 can be detached from the main body 10.

(11) A pair of positioning protrusions 19 are formed on the core metal 15, and the base plate 20 is formed with a plurality of through holes 29 through which the pair of protrusions 19 passes, respectively. According to such a configuration, by disposing the base plate 20 on the core metal 15 so that the pair of protrusions 19 of the core metal 15 penetrate through the pair of through holes 29 of the base plate 20, respectively, the base plate 20 can be easily positioned on the core metal 15. Therefore, it is possible to easily perform the operation of mounting the base plate 20 to the core metal 15 with the screw 60.

### Modified Example

Further, for example, the above embodiment can also be modified as follows.

It is also possible to omit the protrusion 19 for positioning the base plate 20 with respect to the metal core 15 and the through hole 29 of the base plate 20.

The inner diameter of the inner peripheral surface 41A of the holding member 40 may be set to be constant in the axial direction of the holding member 40.

The inclined surface 46 of the holding member 40 can be omitted.

Unevenness may be provided on the inner peripheral surface of the engaging holes 24A to 24C or the outer peripheral surface of the holding member 40 so as to perform positioning by engaging with each other. Further, the engaging holes 24A to 24C can be changed to non-circular holes.

Instead of the engaging holes 24A to 24C, the holding member 40 may be mounted to the mounting portion protruding from the base plate 20, by fitting or the like.

It is also possible to omit the guide surface 28A (guide portion). In this case, the inclined portion 34 of the clip 30 can be omitted.

The shape of the holding portion 26 is not limited to the shape exemplified in the above embodiment. The holding portion may be anything as long as it is possible to hold the respective arms 31 of the clip 30, and may be a hook-shaped portion protruding from the rear surface of the base plate 20. Further, the holding portion 26 can be omitted.

It is also possible to omit the lower holding member 40 provided to correspond to the connecting portion 32 of the clip 30.

In the above embodiment, the description has been given of a case where the snap pin 91 engaged with the clip 30 constitutes the horn switch mechanism 90. Alternatively, a snap pin engaged with the clip 30 may be provided separately from the snap pin of the horn switch mechanism.

What is claimed is:

1. A mounting structure for a driver-seat airbag device for mounting an airbag device to a main body of a steering wheel, the mounting structure comprising:
a core metal provided on the main body of the steering wheel; and
a base plate mounted to the core metal;
a snap pin provided on the airbag device, the snap pin protruding toward the base plate;
a separate holding member mounted to a mounting portion of the base plate; and
a clip engaged with the holding member, wherein
the snap pin is held by the holding member and is engaged with the clip so that the airbag device is mounted to the main body.

2. The mounting structure for the driver-seat airbag device according to claim 1, wherein:
the clip has: a pair of arms disposed with a boss portion of the main body interposed therebetween; and a connecting portion configured to connect base ends of the pair of arms; and
the holding member includes a pair of first holding members provided to correspond to the pair of arms and respectively engaged with the pair of arms.

3. The mounting structure for the driver-seat airbag device according to claim 2, wherein
the holding member includes a second holding member provided to correspond to the connecting portion and engaged with the connecting portion.

4. The mounting structure for the driver-seat airbag device according to claim 2, wherein:
the mounting portion is an engaging hole formed in the base plate; and
the holding member has a storage portion configured to store the snap pin and is engaged with the engaging hole.

5. The mounting structure for the driver-seat airbag device according to claim 4, wherein:
the engaging hole is a circular hole; and
the holding member is rotatably engaged with the engaging hole in a state in which the clip is not engaged with the holding member, and the holding member is non-rotatably engaged with the engaging hole in a state in which the clip is engaged with the holding member.

6. The mounting structure for the driver-seat airbag device according to claim 4, wherein
the base plate is provided with a pair of holding portions capable of holding the pair of arms of the clip, respectively, in a state in which the holding member is not engaged with the engaging hole.

7. The mounting structure for the driver-seat airbag device according to claim 4, wherein
the holding member has a tapered shape toward an end portion on the main body side of the holding member.

8. The mounting structure for the driver-seat airbag device according to claim 7, wherein:
an engaging recess with which the pair of arms are engaged is formed on a peripheral wall of the first holding member;
the first holding member has an inclined surface formed by cutting the peripheral wall so as to incline with respect to a central axis from the engaging recess to a leading end; and
the holding member has the tapered shape toward the end portion on the main body side of the holding member by the inclined surface.

9. The mounting structure for the driver-seat airbag device according to claim 4, wherein
an inner peripheral surface of the storage portion of the holding member is reduced in diameter toward the main body.

10. The mounting structure for the driver-seat airbag device according to claim 4, wherein:
each of the pair of arms have: inclined portions which are inclined so as to be closer to each other toward the leading end sides of the pair of arms; and a leading end portion which extends from a leading end of the inclined portion;
an engaging recess with which the leading end portions of the pair of arms are engaged is formed on the peripheral wall of the pair of first holding members;
the pair of first holding members are engaged with the engaging holes in a posture in which the engaging recess is opened inward in a width direction; and
the base plate is provided with a guide portion which is brought into contact with the inclined portions of the pair of arms, respectively, and guides the inclined portions in a direction of coming closer to each other with the movement of the clip from the base end sides of the pair of arms to the leading end sides.

11. The mounting structure for the driver-seat airbag device according to claim 1, wherein:
a plurality of positioning protrusions are formed on the core metal; and
the base plate is formed with a plurality of through holes through which the plurality of protrusions penetrate, respectively.
